(19) United States
(12) Patent Application Publication
(10) Pub. No.: US 2006/0039297 A1
(43) Pub. Date: Feb. 23, 2006

(54) Data network traffic filter and method

(75) Inventor: Christopher McNab, London (GB)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Sound Control Media Protection Limited, London (GB)

(21) Appl. No.: 11/028,733

(22) Filed: Jan. 5, 2005

(30) Foreign Application Priority Data
Aug. 23, 2004 (GB) 0418783.7

(51) Int. Cl. H04L 1/00

(52) U.S. Cl. 370/252; 370/338

(57) ABSTRACT

A traffic filter for a decentralised peer-to peer data network is described. The data network comprises a number of interconnected ultrapeer nodes, each ultrapeer node being arranged to accept connections from a number of leaf nodes; maintain a database identifying material available from each connected leaf node, receive search queries from connected leaf nodes and other ultrapeers, forward received search queries to connected ultrapeers and provide data from the database matching a received search query. The traffic filter includes an ultrapeer node, a filter module and a protected material database. Upon receiving a search query the ultrapeer node is arranged to pass the query to the filter module. The filter module is arranged to analyse the query in dependence on content in the protected material database to determine if the query relates to protected material, the filter module being arranged to filter queries relating to protected material and pass non-filtered queries to the ultrapeer node for subsequent processing.

### FIELD OF THE INVENTION

The present invention relates to a data network traffic filter and filtering method that is particularly applicable for use in decentralised peer-to-peer data networks.

### BACKGROUND TO THE INVENTION

Peer-to-peer (referred to as P2P) data networks are based on a communications model in which each party has the same capabilities and either party can initiate a communication session. In some cases, peer-to-peer communication is implemented by giving each communication node both server and client capabilities. In recent usage, peer-to-peer has come to describe applications in which users can use the Internet to exchange files with each other directly or through a mediating server.

Internet based peer-to-peer networks tend to be transient networks that allow a group of computer users with the same networking program to connect with each other and directly access files from one another's hard drives. Napster and Gnutella are examples of peer-to-peer software.

Each user's machine is referred to as a leaf node within the peer-to-peer network.

Peer-to-peer systems fall into two categories: centralised and decentralised systems.

Centralised systems such as Napster rely on a central server to provide a database of locations of material (i.e. an IP address of a home user PC, along with the file name of a shared file). The database on the central server is regularly updated according to the material that leaf nodes allow to be shared. To obtain material, leaf nodes connect to the central server to search its database of material locations and select an entry based on the location or material. Having determined a location, the leaf node then connects to the location to obtain the file.

Decentralised systems do not use a central server. In order to participate in a decentralised peer-to-peer network, a user must first download and execute a peer-to-peer networking program. After launching the program, the user enters the IP address of another computer belonging to the network. (Typically, the Web page where the user got the download will list several IP addresses as places to begin). Once the computer finds another network member on-line, it will update its list of accessible IP addresses from those held by the network member's PC (who has gotten their IP address list from another user's connection) and so on.

Location of material is determined by propagating search queries from node to node. As this architecture is not particularly efficient, most decentralized systems have evolved to include ultrapeers (also known as Supernodes). Ultrapeers are other end-user client systems that have been automatically selected, based on factors including system uptime, processing power, bandwidth, and other criteria, to act as such ultrapeer within the P2P network. Ultrapeers are distributed throughout the network so that all leaf nodes connect to the network via a local ultrapeer. When an end-user performs a search for “Britney Spears”, the search query would be sent to the local ultrapeer that the client is connected to which would return any results that match the search string. The local ultrapeer then forwards the query to its neighboring ultrapeers, eventually propagating the query throughout the P2P network.

Individual ultrapeers do not need to forward search queries down to their local leaf nodes, as they keep and maintain up-to-date cached lists of files that are being shared by the local users.

While corporations are looking at the advantages of using P2P as a way for employees to share files without the expense involved in maintaining a centralized server and as a way for businesses to exchange information with each other directly, major producers of content, including movie studios and record companies, are extremely concerned about what has become a major use of peer-to-peer networks - the illegal sharing of copyrighted content.

Centralised peer-to-peer networks that have been used to share copyright protected material have largely been shut down due to legal actions concerning copyright infringement by bodies such as the RIAA and the music industry. The success has been primarily due to the fact that the centralized server is easy to identify and therefore shut down using legal action. Once the central server is shut down, the peer-to-peer network no longer operates.

However, decentralised P2P networks are flourishing. The reason for this is because there is no central server that provides the location details in response to user searches, and every node on the network is effectively a server. In the case of the FastTrack network (which the application KaZaA uses), it is estimated that there are over 3 million nodes. As ultrapeers are selected from existing leaf nodes and any leaf node could serve as an ultrapeer, merely shutting down a handful of ultrapeers is not effective. It has been found that decentralized peer-to-peer networks cannot be shut down using the legal avenues that proved so successful for centralized peer-to-peer networks.

### Statement of Invention

According to one aspect of the present invention, there is provided a traffic filter for a decentralised peer-to peer data network, the data network comprising a number of interconnected ultrapeer nodes, each ultrapeer node being arranged to: accept connections from a number of leaf nodes; maintain a database identifying material available from each connected leaf node; receive search queries from connected leaf nodes and other ultrapeers, forward received search queries to connected ultrapeers and provide data from the database matching a received search query,

the traffic filter including an ultrapeer node, a filter module and a protected material database, wherein upon receiving a search query the ultrapeer node is arranged to pass the query to the filter module, the filter module being arranged to analyse the query in dependence on content in the protected material database to determine if the query relates to protected material, the filter module being arranged to filter queries relating to protected material and pass non-filtered queries to the ultrapeer node for subsequent processing.

Ultrapeers form the very backbone of any decentralised P2P network. However, decentralised networks have no authoritative systems, and it is possible to insert a machine into the network as an ultrapeer. A traffic filtering system according to an embodiment of the present invention can be inserted as an ultrapeer. Once inserted, the traffic filter is arranged to operate as a conventional ultrapeer. However, all traffic passing through the traffic filter is checked against a predetermined database of protected material. If the traffic is identified as relating to the protected material then that traffic is filtered. The filtering action can be adjusted as needed but could include not forwarding search queries to neighboring ultrapeers, providing spoof locations in response to search queries, intercepting packets containing the protected material itself and dropping them or replacing them with spoof packets. Not only is traffic to and from leaf nodes filtered but also traffic from other ultrapeer can be filtered. While a single traffic filter may only make marginal difference to the effectiveness of the P2P network, insertion of a number of traffic filters should severely affect the effectiveness of the P2P network to distribute copyright protected materials is severely affected.

Traffic filtering systems according to embodiments of the present invention seek to impact the search functionality that P2P networks and their users rely on to locate and download material (whether protected by Copyright, or otherwise) in a manner that is scalable yet cost effective.

According to another aspect of the present invention, there is provided a traffic filter for a decentralised peer-to-peer data network, the data network comprising a number of interconnected ultrapeer computer systems, each ultrapeer computer system being arranged to: accept connections from a number of leaf computer systems; maintain a database identifying material available from each connected leaf computer system; receive search queries from connected leaf computer systems and other ultrapeer computer systems, forward received search queries to connected ultrapeer computer systems and provide data from the database matching a received search query,

the traffic filter including an ultrapeer computer system, filter means and computer readable memory encoding a database including data for identifying protected material, wherein the ultrapeer computer system of the traffic filter node is arranged to pass received search queries to the filter means, the filter means being arranged to analyze the query in dependence on data in said database to identify if the query relates to protected material, the filter means being arranged to filter queries identified by the filter means as relating to protected material and to pass non-filtered queries to the ultrapeer computer system of the traffic filter for subsequent processing.

According to a further aspect of the present invention, there is provided a method of filtering traffic in a decentralised peer-to-peer data network, the data network comprising a number of interconnected ultrapeer computer systems, each ultrapeer computer system being arranged to: accept connections from a number of leaf computer systems; maintain a database identifying material available from each connected leaf computer system; receive search queries from connected leaf computer systems and other ultrapeer computer systems, forward received search queries to connected ultrapeer computer systems and provide data from the database matching a received search query,

the method comprising:

inserting into said peer-to-peer data network a traffic filtering computer system as an ultrapeer computer system;

analyzing search queries received at the ultrapeer computer system of the traffic filtering computer system in dependence on data identifying protected material to identify if the query relates to protected material;

filtering received search queries identified as relating to protected material; and,

passing non-filtered queries to the ultrapeer computer system of the traffic filtering computer system for subsequent processing.

It will be appreciated that embodiments of the present invention could be implemented in hardware, software or some combination of the two. In one preferred embodiment of the present invention, multiple traffic filters are run as separate entities on the same computer system. Each traffic filter is assigned its own IP address and deals with the peer-to-peer network as a separate entity, although the database of protected material could be shared.

### BRIEF DESCRIPTION OF THE DRAWINGS

Embodiments of the present invention will now be described in detail, by way of example only, with reference to the accompanying drawings in which:

FIG. 1 is a schematic diagram of a decentralised peer-to-peer network incorporating a traffic filter according to an embodiment of the present invention;

FIG. 2 is a schematic diagram of a traffic filter according to an embodiment of the present invention; and,

FIG. 3 is a schematic diagram of a server including a preferred embodiment of the present invention.

### DETAILED DESCRIPTION

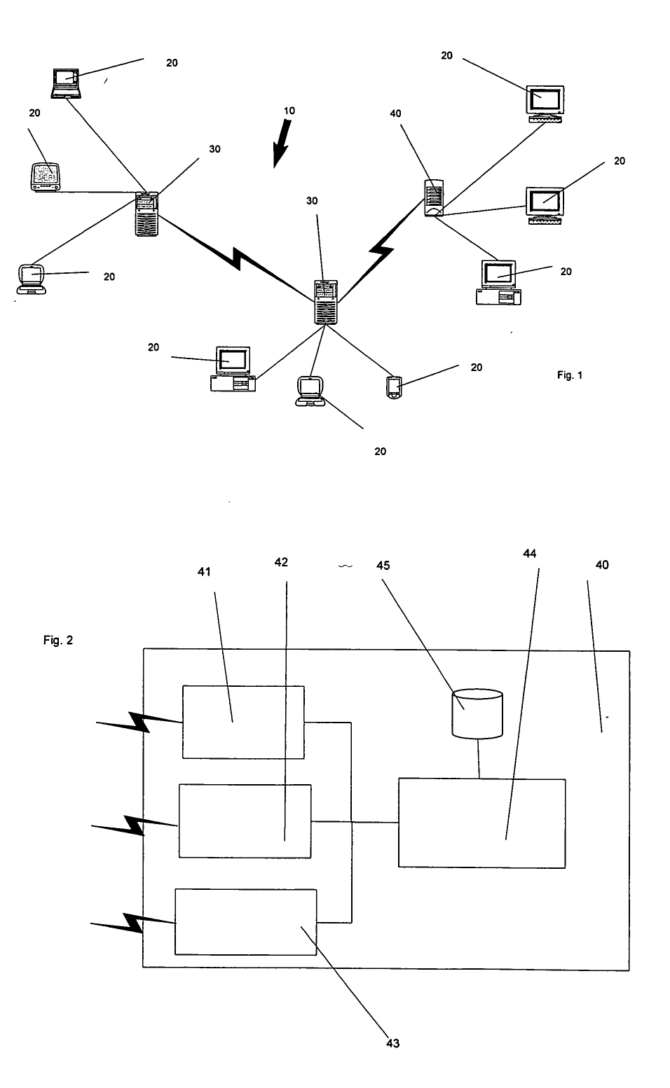

FIG. 1 is a schematic diagram of a decentralised peer-to-peer network incorporating a traffic filter according to an embodiment of the present invention.

The peer-to-peer network 10 includes a number of leaf nodes 20 each connected to a respective ultrapeer node 30.

When a traffic filter 40 according to an embodiment of the present invention connects to the peer-to-peer network 10, it inserts itself as an ultrapeer and allows leaf nodes 20 and other ultrapeers 30 to connect to it.

When leaf node that is connected directly to the traffic filter issues a search query to locate, and eventually download, material the search string is processed by the traffic filter. Processing includes analysing the search query string against a list of strings that correspond to predetermined protected material. Such strings could include artist names, publishers/distributors, song or film titles or other metadata such as hashes from which protected material can be identified. If the search query string analysis matches the search string query to an entry in the list, the traffic filter returns one or more false results. The analysis may include heuristic, semantic or other forms of analysis to identify incorrectly spelt search query strings and attempts to avoid the filtering operation.

If the search query string analysis does not match the search string query then the traffic filter acts as a regular ultrapeer by forwarding the query to its neighboring ultrapeers and also searching for matches to the query in a database identifying material stored by leaf nodes connected to the traffic filter.

The filtering of search query strings is applied to queries from local leaf node and also those forwarded by neighboring ultrapeers.

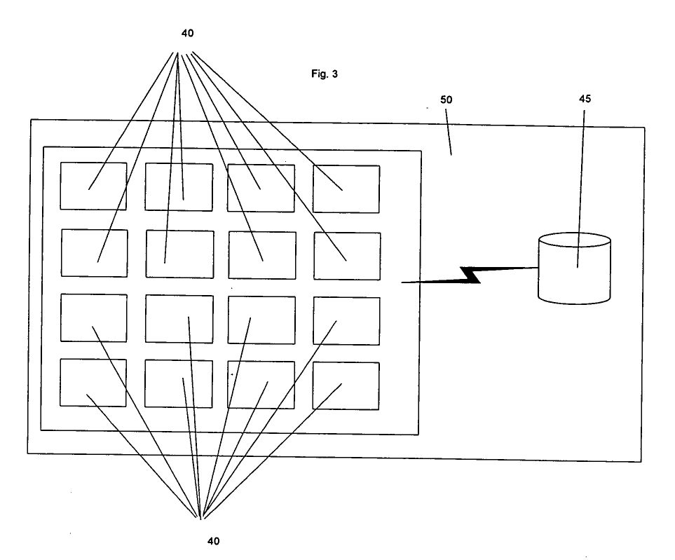

FIG. 2 is a schematic diagram of a traffic filter according to an embodiment of the present invention

The traffic filter 40 includes a number of communication modules 41, 42, 43, a filter module 44, and a protected material database 45.

Each communication module 41, 42, 43 allows the traffic filter to connect to a respective peer-to-peer network type and operate as an ultrapeer in that network. Although there are minor protocol and packet format differences between the various peer-to-peer network types in existence, search query analysis and traffic filtering operates in the same manner. The different communication modules 41-43 handle the coding and decoding of communication packets for the respective network type in accordance with its respective protocol and formats while filter module 44 handles search query analysis and filtering for all network types.

In this embodiment, communication module 41 is connected to the FastTrack peer-to-peer network, communication module 42 is connected to the Gnutella peer-to-peer network and communication module 43 is connected to the Overnet peer-to-peer network. Each communication module deals with insertion into the resepective network as an ultrapeer, handling of general communications (such as answering pings to confirm the node is still active) and receives communication packets for the ultrapeer.

Upon receipt of a communications packet, the communications module extracts the content from the packet and passes this to the filter module 44. The filter module 44 analyses the content, searching for matches or near matches to entries within the protected material database 45 in a manner as discussed above. If a match or near match is found, depending on the programming of the filter the respective communications module is instructed to drop the packet and make no reply or reply with erroneous data. The erroneous data may be a report of material matching the search result but indicating an incorrect IP address for the material. If no match or near match is found then the respective communications module is instructed to act as a standard ultrapeer. Actions taken as a standard ultrapeer may include forwarding the query to neighboring ultrapeers and searching for matches to the query in a database identifying material stored by leaf nodes connected to the traffic filter.

Taking communications module 42 as an example, the process of insertion into the Gnutella network as an ultrapeer and subsequent operation will be described.

The module 42 which connects to a predetermined list of known Gnutella ultrapeers and establishes an ultrapeer-ultrapeer connection with each. Gnutella services can run on any TCP port, and so it is the traffic that is sent which is important.

Inserting into the network as an ultrapeer involves establishing a connection with another ultrapeer using the ‘GNUTELLA CONNECT’ command with ‘X-ultrapeer: True’.

Once inserted as an ultrapeer, traffic is received including:
Query (type 0×80) packets—search queries from leaf nodes
QueryHit (type 0×81) packets—responses to search queries from ultrapeers identifying the location of material satisfying a received search query

Other traffic is also received, including Ping and Pong traffic from other ultrapeers that are sent to ensure the traffic filter (acting as an ultrapeer) is operational and accessible.

In Gnutella, query packets are simple text-based search packets that are propagated throughout the Gnutella network from leaf nodes using ultrapeer nodes.

The text-based query traffic is filtered by the filter module 44 to prevent inappropriate queries being answered or forwarded. Upon receiving a query with a word identified by database 45 as being banned (such as Britney, Madonna, or a trademark), the query is dropped and not forwarded to any of the other neighboring ultrapeers.

QueryHit traffic are results from outbound searches that have been succcessfully propagated. QueryHit packets contain a number of pieces of information including:
IP address of the user sharing the file
File name
File size
XML meta-data

Gnutella 0.4 does not support downloading from multiple sources, and so hash data is not used either in query or QueryHit packets.

QueryHit packets can also be filtered, in particular:
File name
XML meta-data

If the file name or XML meta-data for that file contains words identified by database 45 as being banned (trademarks, artist names, etc.), the QueryHit is dropped and not forwarded to any of the other node (ultrapeer, or leaf nodes).

In some implementations, false QueryHit data may be sent instead of dropping the packet. This is done by taking the QueryHit packet, and modifying the IP address of the user sharing the file, or any other details. By changing the IP address information, the leaf node from where the search originated will not be able to download the file.

Because the Gnutella ultrapeer software runs actively on the Gnutella network, it also accepts direct connections from leaf nodes. Query and QueryHit data is filtered in the same way.

FIG. 3 is a schematic diagram of a server including a preferred embodiment of the present invention.

The server 50 includes a number of traffic filters 40 operating in the same manner as has been discussed above with reference to FIGS. 1 and 2. Each traffic filter 40 is assigned a respective associated IP address for use in communicating with its peer-to-peer networks and operates as a self-contained entity. However, a single prohibited material database 45 is maintained and shared by all of the traffic filters 40. The configuration of each traffic filter may be the same or different—they each may drop packets with prohibited content or replace them with falsified data. This action may be randomly selected, pre-programmed into the traffic filter or may be selected in dependence on the particular content. Similarly, each traffic filter may connect via communication modules to the same peer-to-peer networks or to different ones. From the outside world, the server appears to be a large number of ultrapeers. If each illustrated traffic filter 40 has 3 communication modules 41-43 then to the outside world the server 50 would appear to be 36 individual ultrapeer. If each ultrapeer was to have just 10 leaf nodes connected to it, the traffic of 360 leaf nodes in addition to that received from neighboring ultrapeers could be filtered in an extremely cost effective manner. Although the traffic filters could be implemented as electronic circuits, it is preferred that each traffic filter is software run on the server, the number of traffic filters being limited only by the capabilities of the server and the number of available IP addresses.

Although the embodiments discussed above have been with reference to particular peer-to-peer network types, it will be appreciated that the present invention is applicable to all peer-to-peer network types. In addition, although traffic filters have been illustrated with communication modules connected to FastTrack, Gnutella and Overnet networks, communication modules could be connected to other networks and a traffic filter may include more or less communication modules depending on the implementation. For example on a high traffic network, a single communications module may be connected to a filter module whilst in lower traffic modules, many more communications modules may share the same filter module.

1. A traffic filter for a decentralised peer-to-peer data network, the data network comprising a number of interconnected ultrapeer nodes, each ultrapeer node being arranged to: accept connections from a number of leaf nodes; maintain a database identifying material available from each connected leaf node; receive search queries from connected leaf nodes and other ultrapeers, forward received search queries to connected ultrapeers and provide data from the database matching a received search query,
the traffic filter including an ultrapeer node, a filter module and a protected material database, wherein upon receiving a search query the ultrapeer node is arranged to pass the query to the filter module, the filter module being arranged to analyse the query in dependence on content in the protected material database to determine if the query relates to protected material, the filter module being arranged to filter queries relating to protected material and pass non-filtered queries to the ultrapeer node for subsequent processing.

2. A traffic filter as claimed in claim 1, wherein the filter module is arranged to filter a query by dropping the query.

3. A traffic filter as claimed in claim 1, wherein the filter module is arranged to filter a query by responding with erroneous data.

4. A traffic filter as claimed in claim 1, comprising a plurality of ultrapeer nodes arranged to pass received queries to the filter module.

5. A traffic filter as claimed in claim 4, wherein one or more of the ultrapeer nodes is connected to a different peer-to-peer network.

6. A server including a plurality of traffic filters as claimed in claim 1.

7. A traffic filter for a decentralised peer-to-peer data network, the data network comprising a number of interconnected ultrapeer computer systems, each ultrapeer computer system being arranged to: accept connections from a number of leaf computer systems; maintain a database identifying material available from each connected leaf computer system; receive search queries from connected leaf computer systems and other ultrapeer computer systems, forward received search queries to connected ultrapeer computer systems and provide data from the database matching a received search query,
the traffic filter including an ultrapeer computer system, filter means and computer readable memory encoding a database including data for identifying protected material, wherein the ultrapeer computer system of the traffic filter node is arranged to pass received search queries to the filter means, the filter means being arranged to analyze the query in dependence on data in said database to identify if the query relates to protected material, the filter means being arranged to filter queries identified by the filter means as relating to protected material and to pass non-filtered queries to the ultrapeer computer system of the traffic filter for subsequent processing.

8. A method of filtering traffic in a decentralised peer-to-peer data network, the data network comprising a number of interconnected ultrapeer computer systems, each ultrapeer computer system being arranged to: accept connections from a number of leaf computer systems; maintain a database identifying material available from each connected leaf computer system; receive search queries from connected leaf computer systems and other ultrapeer computer systems, forward received search queries to connected ultrapeer computer systems and provide data from the database matching a received search query,
the method comprising:
inserting into said peer-to-peer data network a traffic filtering computer system as an ultrapeer computer system;
analyzing search queries received at the ultrapeer computer system of the traffic filtering computer system in dependence on data identifying protected material to identify if the query relates to protected material;
filtering received search queries identified as relating to protected material; and,
passing non-filtered queries to the ultrapeer computer system of the traffic filtering computer system for subsequent processing.

9. A method as claimed in claim 8, wherein the step of filtering includes dropping the query.

10. A method as claimed in claim 8, wherein the step of filtering includes responding with erroneous data.

11. A program storage device readable by a machine and encoding a program of instructions for executing the method of claim 8.
